(19) United States
(12) Patent Application Publication
(10) Pub. No.: US 2026/0159360 A1
(43) Pub. Date: Jun. 11, 2026

(54) METHOD AND MOBILE CRANE

(71) Applicant: Liebherr-Werk Ehingen GmbH, Ehingen (DE)

(72) Inventor: Matthias STROEBELE, Oggelsbeuren (DE)

(21) Appl. No.: 19/407,886

(22) Filed: Dec. 3, 2025

(30) Foreign Application Priority Data
Dec. 5, 2024 (DE) 10 2024 136 313.4

(51) Int. Cl. B66C 13/48; B66C 23/76; B66C 23/82

(52) U.S. Cl. CPC B66C 13/48; B66C 23/76; B66C 23/82; B66C 2700/0371

(57) ABSTRACT

The present disclosure relates to a method for controlling a first guying force in a first guying between a boom of a mobile crane and a superstructure of the mobile crane, the first guying force being automatically controlled by setting a second guying force in a second guying between the boom of the crane and a component of the crane.

### CROSS REFERENCE TO RELATED APPLICATION

The present application claims priority to German Patent Application No. 10 2024 136 313.4 filed on Dec. 5, 2024. The entire contents of the above-listed application are hereby incorporated by reference for all purposes.

### TECHNICAL FIELD

The present disclosure relates to a method for controlling a first guying force in a first guying between a boom of a mobile crane and a superstructure of the mobile crane.

### BACKGROUND

It is known from the prior art that a mobile crane has a ballast in order to create a counterweight to a load lifted by the mobile crane. The ballast may in this case be formed by a movable ballast trailer or be arranged on a ballast trailer. The ballast may also be referred to as derrick ballast.

### SUMMARY

Mobile cranes with ballast or derrick ballast are disclosed, for example, in U.S. Pat. No. 11,235,961 B2, EP 0 989 087 A1, JP 6260591 B, JP 7230895 B and EP 3 925 924 A4.

It is furthermore known that the ballast trailer of a mobile crane known from the prior art is connected to an auxiliary boom of the crane by a guying, the auxiliary boom being connected to a superstructure of the crane by a further guying.

The guyings are subjected to corresponding guying forces. When the mobile crane is moving, these guying forces change. In particular when the superstructure is slewed or when the mobile crane is driven over uneven ground, considerable changes in the guying force in the guying between the auxiliary boom and the superstructure can occur.

To control the guying forces in the guyings, it is known from the prior art that the guying between the auxiliary boom and the ballast trailer is variable in length by means of ballast lifting cylinders present in the guying, whereby the ballast trailer or the ballast arranged on the ballast trailer can be raised or lowered and/or whereby the force which the ballast trailer introduces into the auxiliary boom via the guying can be varied.

The control of the ballast lifting cylinders is performed manually by an operator by means of four operating elements on the dashboard of the mobile crane.

These four operating elements are shown in FIG. 2, which illustrates an excerpt from an operating manual of a mobile crane. FIG. 2 likewise reveals the functional description of these four operating elements.

When the operating elements “Raise derrick ballast” and “Lower derrick ballast” are actuated, both ballast lifting cylinders are actuated in the same way.

Against this background, it is an object of the present disclosure to provide a method by means of which control over the guying force in a guying of a mobile crane can be improved.

This object is achieved by the method having the features described herein.

Accordingly, it is provided according to the disclosure that the first guying force is automatically controlled by setting a second guying force in a second guying between the boom of the crane and a component of the crane.

The method is optionally a computer-implemented method.

Optionally, the component is a ballast trailer.

The ballast trailer may be implemented by arranging a ballast on a “self-propelled modular transporter” (SPMT). The ballast trailer may be self-propelled.

Optionally, provision is made for the control of the first guying force and/or the setting of the second guying force to take place during travel of the mobile crane, after travel of the mobile crane, during slewing and/or after slewing of the superstructure.

Optionally, one or more lifting elements, for example hydraulic cylinders, are arranged in the second guying, and the setting of the second guying force is effected by setting the length of the lifting element or lifting elements and thereby the length of the second guying.

The hydraulic cylinder may also be referred to as a ballast lifting cylinder.

Optionally, the length of the second guying is changed only very slightly, for example only on the order of centimetres or decimetres.

In addition or alternatively, the control (regulation) of the first guying force can also be performed in the form of open-loop control of the first guying force, the second guying force and thus the length of the second guying being set manually by an operator.

In other words, the second guying force can optionally be set by setting or changing the length of the lifting element or lifting elements and/or of the second guying.

Optionally, provision is made for the automatic control of the first guying force to begin after a command from an operator of the mobile crane and/or after release by a control unit of the mobile crane.

Optionally, one or more measuring elements, for example measuring links, are arranged in the first guying, which are designed and arranged to measure the first guying force.

Optionally, the first guying force is controlled to a setpoint or setpoint range and/or the setpoint or setpoint range is specified by teaching in a measured value of the first guying force.

Optionally, during control the second guying force is kept within a predetermined value range, for example as a function of the first guying force.

Optionally, the first and/or second guying force is held within a defined range.

Optionally, provision is made for the control of the first guying force to be performed in a control loop with a measured value of the first guying force as the actual value, a predetermined value or value range of the first guying force as the setpoint or setpoint range, and an adjustable value of the second guying force and/or of the length of the second guying as the manipulated variable.

Optionally, the boom is an auxiliary boom or a derrick boom.

The disclosure also relates to a mobile crane, for example a crawler crane, having a boom, a superstructure and a component, for example a ballast trailer, wherein a first guying is provided between the boom and the superstructure and a second guying is provided between the boom and the component, the mobile crane having means which are designed to carry out a method according to the disclosure.

Optionally, no additional components are required for implementing the disclosure on a mobile crane known from the prior art.

Optionally, the disclosure increases the operating convenience of the mobile crane and provides added value in terms of operating speed.

Since the first guying force is continuously monitored and maintained by controlling or setting the second guying force and thus by setting the length of the ballast lifting cylinders, it may be no longer necessary to interrupt a slewing and/or travelling movement of the mobile crane in order to manually correct the length of the ballast lifting cylinders.

Optionally, the availability of the mobile crane is increased because shutoff limits of the first guying force and/or of the oil pressure in the main-boom backstops and/or in the auxiliary-boom backstops cannot be unintentionally exceeded in the method according to the disclosure. Exceeding the shutoff limits usually leads to a stop of every travelling or slewing movement of the mobile crane. When the method according to the disclosure is carried out during operation of the mobile crane, fewer stop commands therefore may be issued by the crane controller.

At this point it should be noted that the terms “a” and “an” do not necessarily refer to exactly one of the elements, although this is one possible embodiment, but can also designate a plurality of the elements. Likewise, the use of the plural also includes the presence of the respective element in the singular, and conversely the singular also encompasses a plurality of the respective elements. Furthermore, all features of the disclosure described herein can be combined with one another as desired or claimed in isolation from one another.

### BRIEF DESCRIPTION OF THE FIGURES

Further advantages, features and effects of the present disclosure will become apparent from the following description of exemplary embodiments with reference to the figures, in which identical or similar components are designated by the same reference numerals. In the drawings:

FIG. 1: a sketch of an embodiment of a mobile crane according to the disclosure.

FIG. 2: a table with operating elements for a prior-art mobile crane and a functional description thereof.

### DETAILED DESCRIPTION

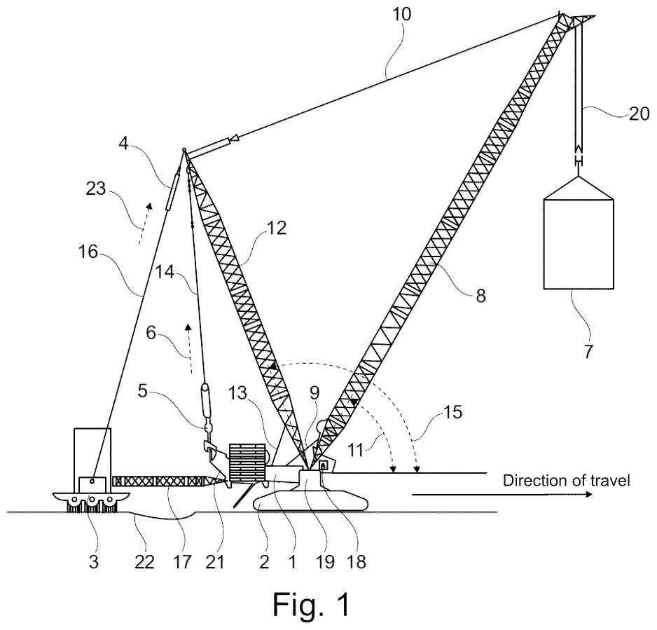

On the mobile crane shown in FIG. 1 in the form of a crawler crane, a load 7 is suspended from the main boom 8 via the hoisting rope 20.

The main boom 8 is connected to the auxiliary boom 12 via a main-boom guying 10 and is luffable.

The auxiliary boom 12 is connected to the superstructure 21 by the first guying 14.

In addition, the auxiliary boom 12 is also connected to the ballast trailer 3 via the second guying 16. In the second guying 16, the second guying force F2 arises, which is symbolically represented by the arrow with the reference numeral 23 in FIG. 1.

The second guying 16 has two ballast lifting cylinders 4 arranged in parallel as lifting elements. One of the ballast lifting cylinders 4 is arranged on the left and the other ballast lifting cylinder 4 is arranged on the right. The ballast lifting cylinders 4 are variable in length, as a result of which the second guying 16 is variable in length.

The ballast trailer 3 is kept at a constant distance from the crawler crane 1 by a guide 17.

The second guying force F2 relates to the forces which are absorbed by the weight of the ballast trailer 3 after the load 7 has introduced into the boom system a moment rotating to the right in FIG. 1.

The crawler crane 1 has a crane controller 18.

The first guying force F1 that arises in the first guying 14 due to the load 7, and which is symbolically represented by the arrow with the reference numeral 6 in FIG. 1, is measured by two tension measuring links 5 each having two measuring cells and is processed by the crane controller 18.

A change in the first guying force F1 with a constant load 7 can be brought about by changing the main boom angle, which is symbolically represented by the curved arrow with the reference numeral 11 in FIG. 1, by changing the auxiliary boom angle, which is symbolically represented by the curved arrow with the reference numeral 15 in FIG. 1, or by changing the length of the second guying 16 by means of the ballast lifting cylinders 4.

A ballast automation function is programmed as a control program on the crane controller 18. The ballast automation comprises commands which, when the ballast automation is executed, carry out a method according to the disclosure on the mobile crane.

The ballast automation can be executed on the crane controller 18. The ballast automation assists the operator of the crawler crane 1 when travelling with the crawler crane 1 by means of the crawler undercarriage 2 and when slewing the superstructure 21 of the crawler crane 1 by means of the slewing gear 19 to which a ballast trailer 3 is attached.

The ballast automation generates control commands by means of which, when required, the ballast lifting cylinders 4 are automatically tracked or their length is changed.

The ballast automation is a support program to assist slewing and travelling of the crawler crane 1. If the operator of the crawler crane 1 selects it, the crane controller 18 enables the function under certain conditions. One condition is, for example, that the crawler crane 1 is in the operating state, i.e. that it is set up to such an extent that the crawler crane 1 can lift a load 7. A further condition is, for example, that no load-limiting movement stops have been triggered by the crane controller 18.

After the ballast automation has been selected, for example by actuating a key, the ballast automation stores the current first guying force F1 provided by the crane controller 18. The first guying force F1 is then taught in for the ballast automation.

The first guying force F1 is composed of a plurality of components which interact in order to keep the entire boom system with main boom 8 and auxiliary boom 12 stable and safe. This means that the entire boom system tilts neither forwards in the direction of the load 7 nor backwards in the direction of the ballast trailer 3.

By retracting the ballast lifting cylinders 4, the length of the second guying 16 is shortened. The second guying force F2 increases, since it opposes more force to the moment rotating to the right in FIG. 1 caused by the load 7, and the first guying force F1 becomes smaller.

By extending the ballast lifting cylinders 4, the length of the second guying 16 is increased, the guying force F2 becomes smaller and the first guying force F1 becomes larger.

This change in the first guying force F1 by changing the length of the second guying 16 and the resulting change in the second guying force F2 optionally takes place in the method according to the disclosure.

The first guying force F1 and the second guying force F2 together form a moment rotating to the left in FIG. 1, which opposes the moment rotating to the right in FIG. 1 resulting from the load 7. The first guying force F1 is optionally kept within a certain range. If the first guying force F1 is too large, there is a risk that the entire crawler crane 1 will tip forwards onto the ground over its tipping edge. A large first guying force F1, together with its moment, also acts via the slewing gear 19. The slewing gear 19 is thus not only loaded in compression but also with a moment superimposed on the compression. If the first guying force F1 becomes too small, the entire boom system is at risk of tipping backwards and the backstops 9 and 13 must hold their respective booms in position.

The second guying force F2 should also be kept within defined limits. A greater second guying force F2 relieves the slewing gear 19 of the moment and instead increases the pressure to be transmitted in the slewing gear 19.

There is optionally no specification by the crane controller 18 of a predetermined value range of the second guying force F2. The entire ballast trailer 3 or the ballast arranged on the ballast trailer 3 can be raised completely, which leads to a maximum second guying force F2, or the ballast trailer 3 or the ballast arranged on the ballast trailer 3 can be lowered completely, which leads to a minimum second guying force F2. Independent open-loop control or setting of the second guying force F2 is optionally not possible, since the second guying force F2 directly influences the first guying force F1. Thus, the defined limits of the second guying force F2 are optionally specified indirectly by the limits of the first guying force F1 or by the first guying force F1.

Furthermore, the directions of action which define the lever arms of the first guying force F1 and of the second guying force F2 must also be taken into account. The lever arm of the second guying force F2 is more favourable than the lever arm of the first guying force F1.

If, after teaching in the first guying force F1, the crawler crane 1 with the ballast trailer 3 is driven over uneven ground by means of the crawler undercarriage 2 or slewed by means of the slewing gear 19, the ballast automation then calculates, by comparing the stored first guying force F1 with the current first guying force F1, whether the ballast lifting cylinders 4 are to be extended or retracted, i.e. whether the guying 16 is to be lengthened or shortened, in order to keep the current first guying force F1 constant or within a range. Once the result has been determined, the ballast lifting cylinders 4 are actuated in the corresponding direction. This calculation is carried out continuously in order always to maintain the previously taught-in first guying force F1. This is done by means of a known PI controller.

No intervention is made at the block shown in FIG. 1 in the guying 14.

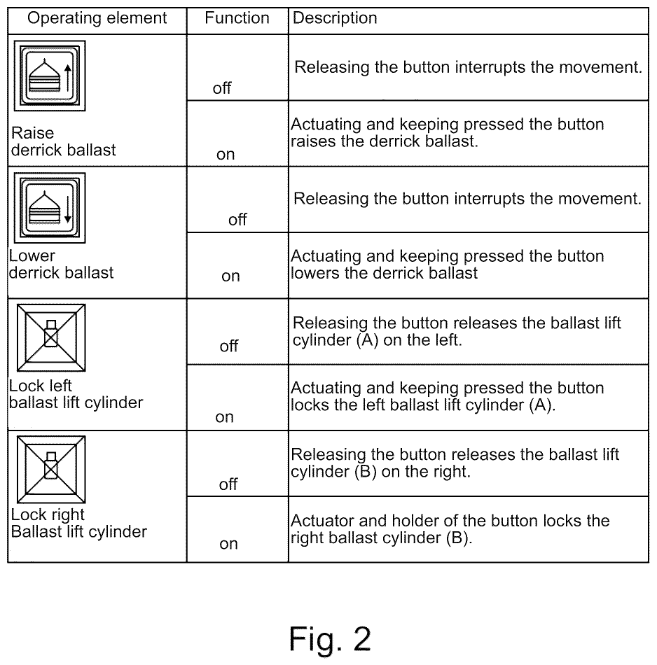

Without active ballast automation, during a slewing or travelling movement the operator can manually set the length of the second guying 16 by means of the ballast lifting cylinders 4 via the four operating elements shown in FIG. 2 on the dashboard of the crane operator's cab, in order to be able to keep the first guying force F1 in the desired range. With the four operating elements on the dashboard, the left and the right ballast lifting cylinder 4 can be extended or retracted.

If the operator does not continuously readjust the ballast lifting cylinders 4 manually, this has an effect on the second guying force F2 and thus on the first guying force F1 when travelling over uneven ground.

The length of the second guying 16 in turn has an effect, in the form of a change in angle, on the main boom angle 11 and the auxiliary boom angle 15. This effect is prevented or kept within narrow limits by the main-boom backstop 9 and the auxiliary-boom backstop 13.

The backstops 9 and 13 consist of hydraulic cylinders which are mounted on the main boom 11 and on the auxiliary boom 12 of the crawler crane 1. These cylinders are extended or retracted depending on an introduced force in order to stabilise the crawler crane 1.

When the ballast trailer 3 travels into a depression 22, the entire boom system with main boom 8 and auxiliary boom 12 is pulled backwards, which results in a redistribution of forces between the second guying force F2 and the first guying force F1. This redistribution results from the fact that the guide 17 keeps the ballast trailer 3 at a constant distance from the crawler crane 1 and thus allows the forces to be redistributed.

This redistribution has, on the one hand, a direct effect on the first guying force F1 and on the main-boom backstop 9 and the auxiliary-boom backstop 13.

The first guying force F1 is optionally within a defined range between a minimum force and a maximum force. These limits are defined by the load charts and monitored by the crane controller 18. If these limits are exceeded, this results in the travelling or slewing movement being stopped.

As a result of the unwanted redistribution of forces, the backstops 9 and 13 are compressed, the oil present in the backstops is compressed and the oil pressure increases. In this case, the oil pressure in the backstops 9 and 13 can exceed the maximum permissible oil pressure, which results in the travelling or slewing movement being stopped. The oil pressure is measured and monitored. For the ballast automation or the method according to the disclosure, however, it is not a manipulated variable or control variable. The oil pressure is a result of the control by the ballast automation.

After activation of the ballast automation, the ballast automation takes over the readjustment of the ballast lifting cylinders 4.

The first guying force F1 remains constant or within a range and the operator can therefore concentrate more on the slewing and travelling movements. The minimum and maximum force limits of the first guying force F1 are not reached and the crawler crane 1 does not enter a travel or slewing stop.

Likewise, the oil pressures in the main-boom backstop 9 and the auxiliary-boom backstop 13 remain constant or within narrow limits, since only a small redistribution of forces occurs in the boom system due to uneven ground.

From FIG. 2, four operating elements for manual control of the first guying force F1 and for manual setting of the second guying force F2 are evident. The operating elements are designed as push-buttons.

Alternatively or in addition to the method according to the disclosure, the operator of the crawler crane 1 can actuate the ballast lifting cylinders 4 via the four operating elements from FIG. 2.

By actuating and holding the first operating element from the top in FIG. 2, the ballast lifting cylinders 4 are shortened, whereby the ballast trailer 3 or the ballast arranged on the ballast trailer is raised and the second guying force F2 increases. Releasing the operating element interrupts the lifting.

By actuating and holding the second operating element from the top in FIG. 2, the ballast lifting cylinders 4 are lengthened, whereby the ballast trailer 3 or the ballast arranged on the ballast trailer is lowered and the second guying force F2 decreases. Releasing the operating element interrupts the lowering.

By actuating and holding the third operating element from the top in FIG. 2, the left ballast lifting cylinder 4 is locked. Releasing the operating element releases the left ballast lifting cylinder 4.

By actuating and holding the fourth operating element from the top in FIG. 2, the right ballast lifting cylinder 4 is locked. Releasing the operating element releases the right ballast lifting cylinder 4.

### LIST OF REFERENCE NUMERALS

1 crawler crane
2 crawler undercarriage
3 ballast trailer
4 ballast lifting cylinder
5 tension measuring links
6 first guying force F1
7 load
8 main boom
9 main-boom backstop
10 main-boom guying
11 main boom angle
12 auxiliary boom
13 auxiliary-boom backstop
14 first guying
15 auxiliary boom angle
16 second guying
17 guide
18 crane controller
19 slewing gear
20 hoisting rope
21 superstructure
22 depression
23 second guying force F2

1. A method for controlling a first guying force in a first guying between a boom of a mobile crane and a superstructure of the mobile crane, wherein the first guying force is automatically controlled by setting a second guying force in a second guying between the boom of the crane and a component of the crane.

2. The method according to claim 1, wherein the component is a ballast trailer.

3. The method according to claim 1, wherein the control of the first guying force and/or the setting of the second guying force takes place during travel of the mobile crane, after travel of the mobile crane, during slewing and/or after slewing of the superstructure.

4. The method according to claim 1, wherein one or more lifting elements are arranged in the second guying and that the setting of the second guying force is effected by setting the length of the one or more lifting elements and thus of the second guying.

5. The method according to claim 1, wherein the automatic control of the first guying force begins after a command from an operator of the mobile crane and/or after release by a control unit of the mobile crane.

6. The method according to claim 1, wherein one or more measuring elements are arranged in the first guying, which are designed and arranged to measure the first guying force.

7. The method according to claim 1, wherein the first guying force is controlled to a setpoint or setpoint range, and/or the setpoint or setpoint range is specified by teaching in a measured value of the first guying force.

8. The method according to claim 1, wherein during control the second guying force is kept in a predetermined value range.

9. The method according to claim 7, wherein the control of the first guying force is carried out in a control loop with the measured value of the first guying force as the actual value, a predetermined value or value range of the first guying force as the setpoint or setpoint range, and an adjustable value of the second guying force and/or the length of the second guying as the manipulated variable.

10. The method according to claim 1, wherein the boom is an auxiliary boom or a derrick boom.

11. A mobile crane having a boom, a superstructure and a component, wherein a first guying is provided between the boom and the superstructure and a second guying is provided between the boom and the component, the mobile crane having means which are designed to carry out the method according to claim 1.

12. The method according to claim 4, wherein the one or more lifting elements comprise hydraulic cylinders.

13. The method according to claim 6, wherein the one or more measuring elements comprise measuring links.

14. The method according to claim 8, wherein the second guying force is kept in the predetermined value range as a function of the first guying force.

15. The mobile crane according to claim 11, wherein the mobile crane is a crawler crane.

16. The mobile crane according to claim 11, wherein the component is a ballast trailer.
